(19) United States
(12) Patent Application Publication
(10) Pub. No.: US 2008/0059702 A1
(43) Pub. Date: Mar. 6, 2008

(54) Portable storage device with operating status display

(76) Inventors: Chien-Jung Lu, Taoyuan City (TW); Ying-Ching Lee, Taipei City (TW); Hsiang-An Hsieh, Sijhih City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/634,184

(22) Filed: Dec. 6, 2006

(30) Foreign Application Priority Data
Aug. 29, 2006 (TW) 95215287

(51) Int. Cl. G06F 12/00

(52) U.S. Cl. 711/115

(57) ABSTRACT

A portable storage device with operating status display is applied for a processor-based system. The portable storage device includes a storage medium, a control unit, an operating-status-analysis driving unit and a display unit. The control unit receives an access signal from the processor-based system, in order to record and read the information saved in the storage medium to generate a record-and-read signal. The operating-status-analysis driving unit electrically connects with the control unit to give a driving signal after analyzing the record-and-read signal. The display unit receives the driving signal for demonstrating information about an operating status. Therefore, the operating status of the portable storage device is informed in real time.

### BACKGROUND OF THE INVENTION

1. Field of the Invention

The present invention relates to a portable storage device, particularly relates to a portable storage device with operating status display.

2. Background of the Invention

As 3C industries develop rapidly with requirements of information storage and fast transmission, storage device grows from old-fashioned ones, such as magnetic tape drives, magnetic disk drives, hard disk drives and optical disk drives, to new-fashioned ones, portable storage devices, nowadays, such as memory card mobile readers or flash drives.

On conventional storage devices, the way for indicating on/off or read/record mode is providing LEDs with various colors or with different flashes. However, the manner mentioned above only indicates the power is on or off or the device is under operation or idle state. Concerning about detailed operating status of the device, it's failed for the conventional storage device.

In addition, display components, which can indicate the rest of available capacity or tags of magnetic disk drives, are adapted for the storage devices due to the development of the portable storage device. Such as liquid crystal modules, electronic papers, seven-segment LED displays, or ladder-typed LED displays. TW Patent No. M284062, entitled “storage medium device displaying available capacity”, discloses an electronic paper for demonstrating the information about available capacity. TW Patent No. 537462, entitled “portable storage device having a display of available capacity”, discloses a seven-segment LED display or a ladder-typed LED display for demonstrating the information about available capacity. U.S. application patent Ser. No. 10/994,271 (, Publication No 2006/009547), discloses a portable storage device with an electronic display. Furthermore, JP Patent No. 4-103072, 4-135229 and US Publication No. 2003/0067702 all disclose static information can be saved first and showed on an appropriate display then. Nevertheless, patents mentioned above only provide static information recorded and indicated. For example, capacity the information occupied, available capacity, the proportion of available capacity to unavailable capacity, tag of the magnetic disk drive. But information about operating status, such as status of data transmission (read or record) or access speed, is absence, while the storage device connects with a system.

Obviously, although the conventional storage device provides static information through various types of displays and provides status thereof through LEDs, the real time information about operating status or access speed cannot be indicated immediately. Hence, an improvement over the prior art is required to overcome the disadvantages thereof.

### SUMMARY OF THE INVENTION

The primary object of the invention is therefore to specify a portable storage device can indicate operating status in time. Through analyzing the operating status, the read/record status of the storage device can be automatically detected. Then a display can be driven or LEDs can be illuminated in sequence with different speed, illumination or color. Therefore, the real-time operating status can be acquired and displayed for recognizing different states.

According to the invention, the object is achieved to provide a portable storage device with operating status display applied for a processor-based system. The portable storage device includes a storage medium, a control unit, an operating-status-analysis driving unit and a display unit. The storage medium saves information. The control unit receives an access signal from the processor-based system, in order to record and read the information saved in the storage medium to generate a record-and-read signal. The operating-status-analysis driving unit electrically connects with the control unit to give a driving signal after analyzing the record-and-read signal. The display unit receives the driving signal for demonstrating information about an operating status.

According- to the invention, another object is achieved to provide a portable storage device further including a control signal to the operating-status-analysis driving unit for changing a demonstration mode or a time regulation mode, or the control signal commands the display unit directly. Therefore, the operating status displays of the portable storage device can be diversified for meeting user's favorite.

To provide a further understanding of the invention, the following detailed description illustrates embodiments and examples of the invention. Examples of the more important features of the invention thus have been summarized rather broadly in order that the detailed description thereof that follows may be better understood, and in order that the contributions to the art may be appreciated. There are, of course, additional features of the invention that will be described hereinafter which will form the subject of the claims appended hereto.

### BRIEF DESCRIPTION OF THE DRAWINGS

These and other features, aspects, and advantages of the present invention will become better understood with regard to the following description, appended claims, and accompanying drawings, where:

FIG. 1 is a block diagram of a portable storage device with operating status display according to the present invention;

FIG. 2 is a block diagram of an operating-status-analysis driving unit according to the present invention; and

FIG. 3 is a perspective view of the portable storage device according to a first embodiment of the present invention;

FIG. 3A is an operation diagram of an idle state of the portable storage device according to the first embodiment of the present invention;

FIG. 3B is an operation diagram of a read state of the portable storage device according to the first embodiment of the present invention;

FIG. 3C is an operation diagram of a record state of the portable storage device according to the first embodiment of the present invention;

FIG. 4 is a perspective view of the portable storage device according to a second embodiment of the present invention;

FIG. 4A is an operation diagram of a read state of the portable storage device according to the second embodiment of the present invention;

FIG. 4B is an operation diagram of a record state of the portable storage device according to the second embodiment of the present invention;

FIG. 5 is a perspective view of the portable storage device according to a third embodiment of the present invention; and

FIG. 6 is a perspective view of the portable storage device according to a fourth embodiment of the present invention.

### DETAILED DESCRIPTION OF THE EMBODIMENTS

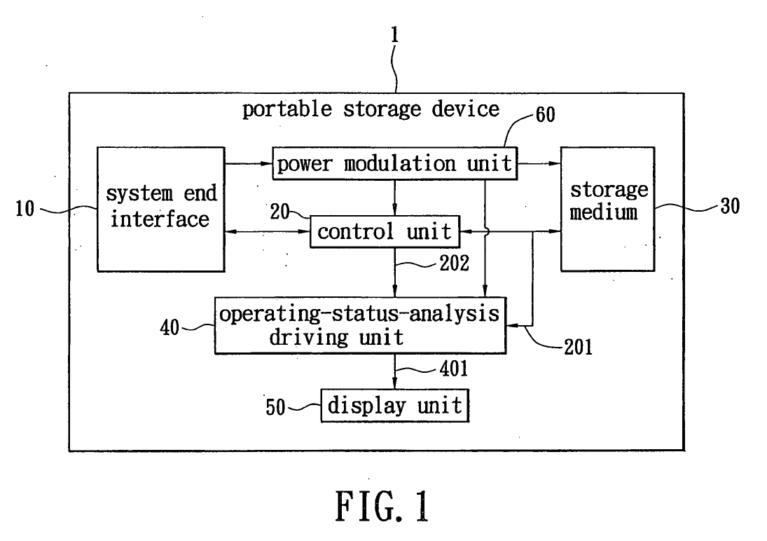

Referring to FIG. 1, a block diagram of a portable storage device 1 with operating status display according to the present invention is illustrated. The portable storage device 1 is applied for a processor-based system (not shown), and includes a system end interface 10, a control unit 20, a storage medium 30, an operating-status-analysis driving unit 40, a display unit 50 and a power modulation unit 60. The system end interface 10 connects with and accesses the processor-based system, so that the processor-based system can get the information saved in the storage medium 30 of the storage device 1. The storage medium 30 can be a magnetic recording medium, an optical recording medium or a non-volatile memory recording medium. The control unit 20 electrically connects with the system end interface 10 and storage medium 30, and receives an access signal from the processor-based system via the system end interface 10, in order to record and read the information saved in the storage medium 30 to generate a record-and-read signal 201. The operating-status-analysis driving unit 40 electrically connects with the control unit 10 to give a driving signal 401 after analyzing the record-and-read signal 201. The record-and-read signal 201 is a row data for operating-status-analysis driving unit 40 while analyzing an operating status.

The display unit 50 receives the driving signal 401 for demonstrating information about the operating status. The display unit 50 may be a liquid display module, a bistable liquid display module, electronic paper or a plurality of LEDs, which can be monochrome LEDs or multicolor LEDs. The operating status after analyzing will be an idle state, a read state, a record state or an access speed.

The display unit 50 indicates information according to predetermined indication modes of the operating-status-analysis driving unit 40. Besides, the control unit 20 further generates control signal 202 to the operating-status-analysis driving unit 40 for changing the predetermined demonstration modes or a time regulation mode, or the control signal commands the display unit 50 directly. The control signal 202 can be generated after executing an application program of the processor-based system, so that the user can input and has personal demonstration mode.

The control unit 20 and the operating-status-analysis driving unit 40 are arranged individually illustrated in FIG. 1. The operating-status-analysis driving unit 40 can be implemented by built in the control unit 20, and the operating-status-analysis driving unit 40 is achieved by hardware or procedures form firmware inside the control unit 20. The power modulation unit 60 gains a power from the processor-based system via the system end interface 10, and modulates a new power for each unit of the portable storage device 1. Besides the power modulation unit 60 is arranged individually, it also can be built in the control unit 20 for saving cost and space.

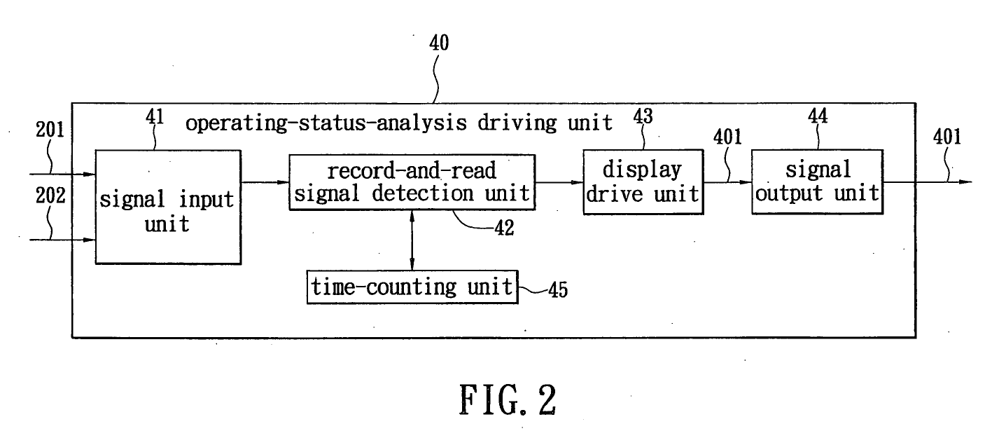

With respect to FIG. 2, a block diagram of the operating-status-analysis driving unit 40 according to the present invention is illustrated. The operating-status-analysis driving unit 40 includes a signal input unit 41, a record-and-read signal detection unit 42, a display drive unit 43, a signal output unit 44 and a time-counting unit 45. The signal input unit 41 receives the record-and-read signal 201 and the control signal 202 of the control unit 20. The time-counting unit 45 generates a time-counting signal for counting the required time unit of data transmission. The record-and-read signal detection unit 42 analyzes the record-and-read signal 201 according to the time-counting signal for judging the state of action. The display drive unit 43 electrically connects with the record-and-read signal detection unit 42 for receiving the judgment of the state to output the driving signal 401. The driving signal 401 can be transmitted to the display unit 50 via the signal output unit 44. Therefore, the driving signal 401 can drive the display unit 50 after the display drive unit 43 received the record-and-read signal 201 from the record-and-read signal detection unit 42; alternatively, the driving signal 401 can command the display unit 50 directly while the display drive unit 43 further receives the control signal 202.

Operations of the operating-status-analysis driving unit 40 are further exampled below. When the portable storage device 1 connects with the processor-based system via the system end interface 10, the power modulation unit 60 modulates and output the power for each unit of the storage device 1. The portable storage device 1 is at a standby state and display unit 50 will show a demonstration mode of standby state, after the record-and-read signal detection unit 42 judges the operating status and the display drive unit 43 drives the display unit 50. When the operating-status-analysis driving unit 40 obtains the control signal 202, the demonstration mode of the display drive unit 43 or the time counting mode of the time-counting unit 45 will changes in accordance with the control signal 202. In addition, when the record-and-read signal 201 results from an accessing indication of the processor-based system, the record-and-read signal detection unit 42 will add up the data quantity of reading or recording. When time due to the time-counting signal of time-counting unit 45 goes up to the predetermined setting time (, set by application program), the record-and-read signal detection unit 42 will gather statistics and analyze accumulations of the data quantity in order to have an judgment of operating status. The display drive unit 43, corresponding to the judgment of the record-and-read signal detection unit 42, modify the operating status of the display unit 50 in real time.

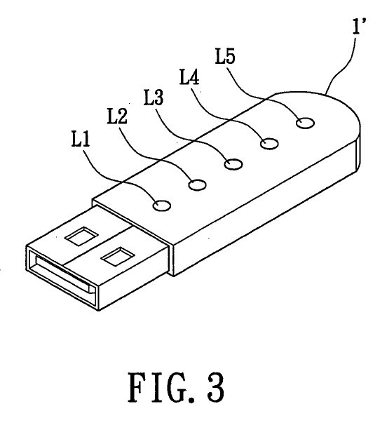

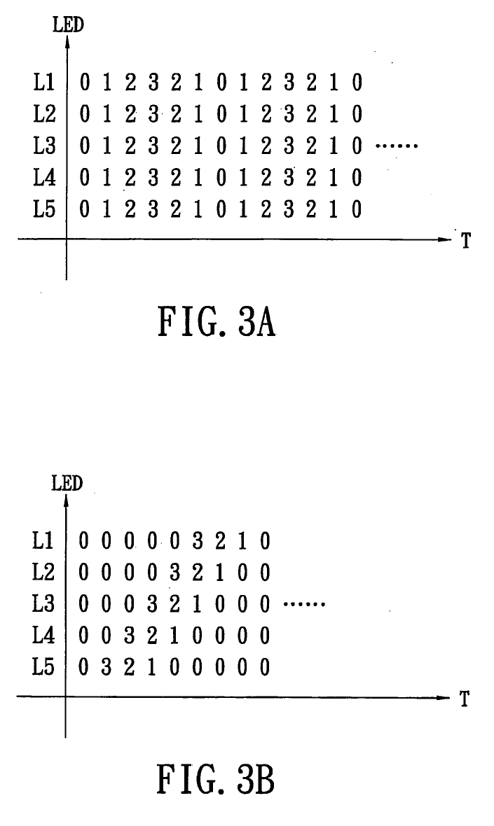

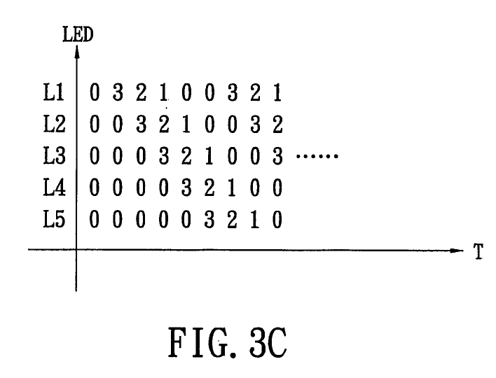

FIG. 3 illustrates the portable storage device 1 according to a first embodiment of the present invention. The portable storage device 1 is the flash drive 1′. The display unit 50 is arranged by five LEDs L1˜L5 in line. All the LEDs L1˜L5 will light or not, change the illumination or color thereof in correspondence with the operating status of the flash drive 1′. And the combination of changes and locations of the LEDs L1˜L5 will tell the exact operating status of the flash drive 1′. For example, if the flash drive 1′ is at the standby state, the LEDs L1˜L5 can be all illuminated or all extinguish. For further entertaining effect, the LEDs L1˜L5 can change the illumination at the same speed slowly. If the flash drive 1′ is at the read state, most LEDs can light with the same period, such as the first LED L1, the second LED L2 and the third LED L3, but with various illuminations, a moving spot formed by the three LEDs can indicate the transmission speed of information. The faster the moving spot acts, the quicker the transmission speed is. Therefore, the user can easily know the real situation of data transmission.

Referring to FIG. 3A, the flash drive 1′ is at the idle state, the values shown in FIG. 3A represent the illumination values of the LEDs L1˜L5. In this embodiment, the illumination are expressed by four stages, 3 means the most brightness, 2 means ⅔ brightness, 1 means only ⅓ brightness, and zero means the extinguishment. At the first period, all the LEDs L1˜L5 go out; at the second period, all the LEDs L1˜L5 have ⅓ brightness; and so on. All the LEDs L1˜L5 will have bright illumination at the same time and go out at the same time. Between the most brightness and the extinguishment, the LEDs L1˜L5 will change the illumination gradually.

Referring to FIG. 3B, the flash drive 1′ is at the read state. Differing from FIG. 3A, the illumination order of the LEDs L1˜L5 is contrary, such as is from the flash drive 1′ to the processor-based system (, from the fifth LED L5 to the first LED L1). At the first period, all the LEDs L1˜L5 go out; at the second period, all the LEDs L1˜L5 have the most brightness; at the third period, the LEDs L1˜L4 have the most brightness and the fifth LED L5 has ⅔ brightness; at the fourth period; the LEDs L1˜L3 have the most brightness, the fourth LED L4 has ⅔ brightness and the fifth LED L5 has ⅓ brightness; and so on. In this embodiment, a moving indication is provided and further with tail special efficacy. These periods are inversely proportion to the transmission speeds. That means the faster the real transmission speed is, the quicker the moving indication is.

Referring to FIG. 3C, the flash drive 1′ is at the record state. Differing from FIG. 3B, the illumination order of the LEDs L1˜L5 is contrary, such as is from the processor-based system to the flash drive 1′ (, from the first LED L1 to the fifth LED L5). The moving indication and further with tail special efficacy is also provided.

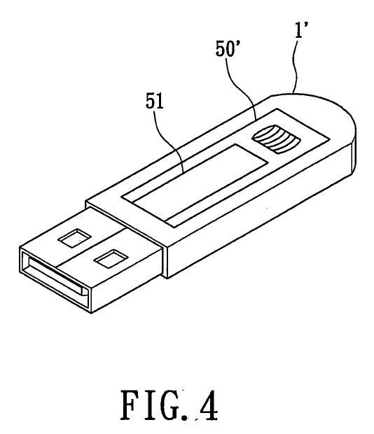

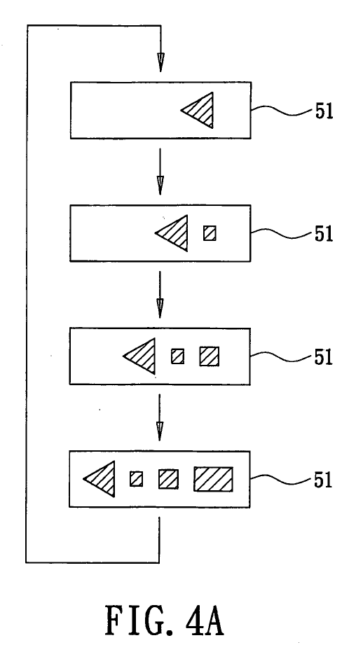

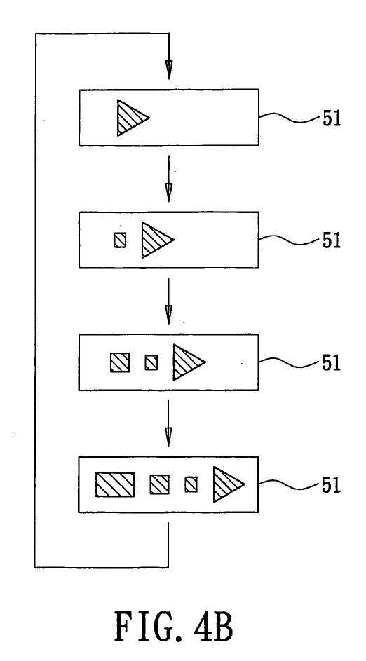

FIG. 4 illustrates the portable storage device 1 according to a second embodiment of the present invention. The portable storage device 1 also is the flash drive 1′. The display unit 50 is a LCD 50′, which includes an operating-status display area 51 for demonstrating the state of the portable storage device 1. When the flash drive 1′ is at the standby state, the operating-status display area can be clear and blank.

Referring to FIG. 4A, the flash drive 1′ is at the read state. The moving indication on the operating-status display area 51 is from the flash drive 1′ to the processor-based system, so that the repeat indication specifies the read state of the flash drive 1′. At the same time, the repeat speed of the moving indication also shows the real transmission speed.

Referring to FIG. 4B, the flash drive 1′ is at the record state. Differing from FIG. 4A, the illumination order of the LEDs L1˜L5 is from the processor-based system to the flash drive 1′.

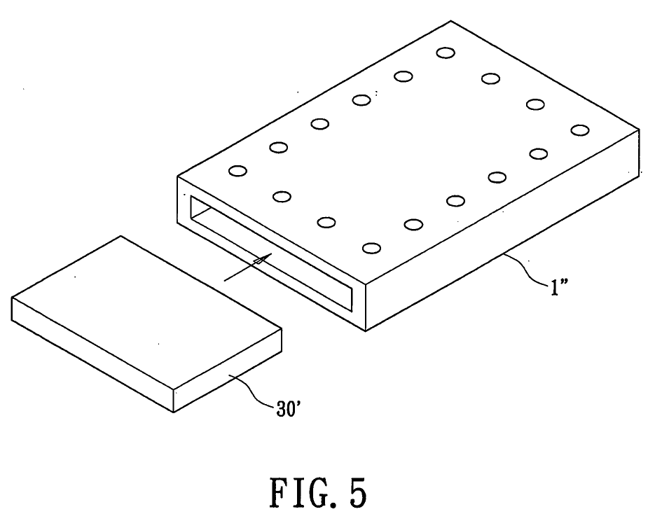

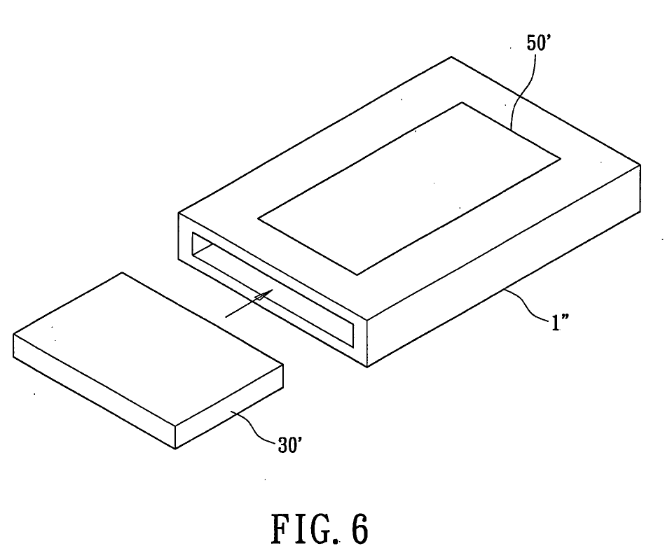

FIG. 5 and 6 illustrates the portable storage device 1 according to a third and fourth embodiment of the present invention respectively. The portable storage device 1 can be adapted for a card reader 1″ and a memory card 30′. Illustrated in FIG. 5, the card reader 1″ includes a plurality of LEDs surrounding thereof. The LEDs form the normal and inverse circle directions in read or record state. Illustrated in FIG. 6, the card reader 1″ includes the LCD 50′, which also can indicate the operating status while the memory card 30′ applies.

The LCD 50′ can show not only the gradual dragging moving indication, but also other patterns or characters which are able to reveal the operating status.

Concluding the description mentioned above, the portable storage device 1 can detect the read/record state automatically and further modify the demonstration of the display unit in real time. No more cost will raise the additional values of the portable storage device, and motive demonstration and personal settings make specific styles for the user.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. A portable storage device with operating status display, which is applied for a processor-based system, comprising:
a storage medium saving information;
a control unit receiving an access signal from the processor-based system, in order to record and read the information saved in the storage medium to generate a record-and-read signal;
an operating-status-analysis driving unit electrically connected with the control unit to give a driving signal after analyzing the record-and-read signal; and
a display unit receiving the driving signal for demonstrating information about an operating status.

2. The portable storage device with operating status display as claimed in claim 1, wherein the storage medium is a magnetic recording medium, an optical recording medium or a non-volatile memory recording medium.

3. The portable storage device with operating status display as claimed in claim 1, wherein the control unit further has a control signal to the operating-status-analysis driving unit for changing a demonstration mode or a time regulation mode, or the control signal commands the display unit directly.

4. The portable storage device with operating status display as claimed in claim 3, wherein the control signal is generated by an application program of the processor-based system.

5. The portable storage device with operating status display as claimed in claim 1, wherein the record-and-read signal is a row data for operating-status-analysis driving unit while analyzing the operating status.

6. The portable storage device with operating status display as claimed in claim 1, wherein the operating-status-analysis driving unit further includes:
a signal input unit receiving the record-and-read signal;
a time-counting unit generating a time-counting signal;
a record-and-read signal detection unit analyzing the record-and-read signal according to the time-counting signal for judging the state of action;
a display drive unit electrically connected with the record-and-read signal detection unit for receiving the judgment of the state to output the driving signal; and
a signal output unit transmitting the driving signal to the display unit.

7. The portable storage device with operating status display as claimed in claim 1, wherein the operating-status-analysis driving unit is built in the control unit, and the operating-status-analysis driving unit is achieved by hardware or procedures form firmware inside the control unit.

8. The portable storage device with operating status display as claimed in claim 1, wherein the display unit is a liquid display module, a bistable liquid display module, electronic paper or a plurality of LEDs.

9. The portable storage device with operating status display as claimed in claim 8, wherein the LEDs are monochrome LEDs or multicolor LEDs.

10. The portable storage device with operating status display as claimed in claim 1, wherein the operating status is an idle state, a read state, a record state or an access speed.

11. The portable storage device with operating status display as claimed in claim 1, further including:
a system end interface connected with and accessing the processor-based system; and
a power modulation unit gaining a power from the processor-based system via the system end interface, and modulating a new power for each unit of the portable storage device.

12. The portable storage device with operating status display as claimed in claim 11, wherein the power modulation unit is built in the control unit.
